(19) United States
(12) Patent Application Publication
(10) Pub. No.: US 2012/0180494 A1
(43) Pub. Date: Jul. 19, 2012

(54) TURBINE FUEL NOZZLE ASSEMBLY

(75) Inventors: Donald Mark Bailey, Simpsonville, SC (US); Patrick Benedict Melton, Horse Shoe, NC (US)

(73) Assignee: GENERAL ELECTRIC COMPANY, Schenectady, NY (US)

(21) Appl. No.: 13/006,741

(22) Filed: Jan. 14, 2011

(51) Int. Cl. F02C 7/22

(52) U.S. Cl. 60/772; 60/740

(57) ABSTRACT

According to one aspect of the invention, a fuel nozzle assembly for a turbine includes an inner conduit and a flange coupled to the inner conduit thereby forming a chamber for flow of a gas fuel. In addition, the flange includes a diaphragm member coupled to the inner conduit, the diaphragm member being configured to flex in response to relative movement between the inner conduit and the flange.

### BACKGROUND OF THE INVENTION

The subject matter disclosed herein relates to turbines and, more particularly, fuel nozzles for gas turbines.

In a gas turbine, a combustor converts chemical energy of a fuel or an air-fuel mixture into thermal energy. The thermal energy is conveyed by a fluid, often compressed air from a compressor, to a turbine where the thermal energy is converted to mechanical energy. The fuel and/or air are directed into the combustor via one or more fuel nozzles. In an aspect, the fuel nozzle is an assembly that includes a plurality of components that are made of different materials. A temperature differential between flowing fuel and air within the fuel nozzle assembly can cause thermal expansion and corresponding movement of the nozzle components, causing wear and tear on the components and joints between the components. Reducing stress caused by relative movement of fuel nozzle components will improve durability and reliability of the fuel nozzle and turbine.

### BRIEF DESCRIPTION OF THE INVENTION

According to one aspect of the invention, a fuel nozzle assembly for a turbine includes an inner conduit and a flange coupled to the inner conduit thereby forming a chamber for flow of a gas fuel. In addition, the flange includes a diaphragm member coupled to the inner conduit, the diaphragm member being configured to flex in response to relative movement between the inner conduit and the flange.

According to another aspect of the invention, a method for flowing fuel in a turbine includes directing air within an inner conduit and directing a fuel into a cavity between the inner conduit and a flange, wherein the inner conduit and flange are coupled by a coupling. The method further includes flexing a diaphragm member in the flange to compensate for a movement of the inner conduit, wherein the flexing of the diaphragm member reduces stress on the coupling between the inner conduit and flange.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic drawing of an embodiment of a gas turbine engine, including a combustor, fuel nozzle, compressor and turbine;

FIG. 2 is a side sectional view of an embodiment of a fuel nozzle assembly; and

FIG. 3 is a side sectional view of another embodiment of a fuel nozzle assembly.

The detailed description explains embodiments of the invention, together with advantages and features, by way of example with reference to the drawings.

### DETAILED DESCRIPTION OF THE INVENTION

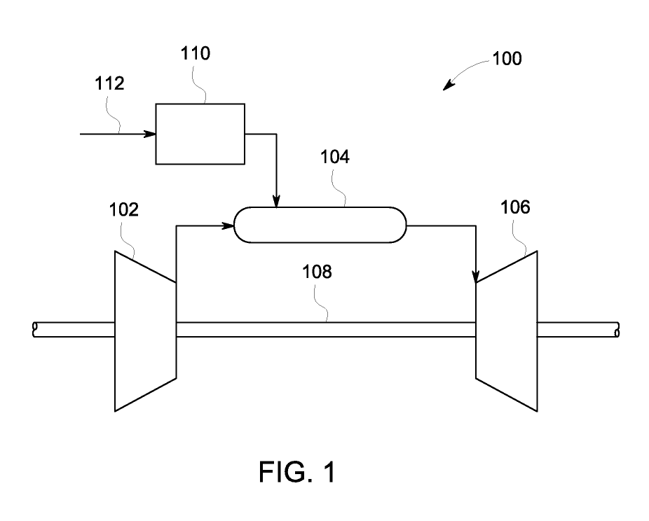

FIG. 1 is a schematic diagram of an embodiment of a gas turbine system 100. The system 100 includes a compressor 102, a combustor 104, a turbine 106, a shaft 108 and a fuel nozzle 110. In an embodiment, the system 100 may include a plurality of compressors 102, combustors 104, turbines 106, shafts 108 and fuel nozzles 110. The compressor 102 and turbine 106 are coupled by the shaft 108. The shaft 108 may be a single shaft or a plurality of shaft segments coupled together to form shaft 108.

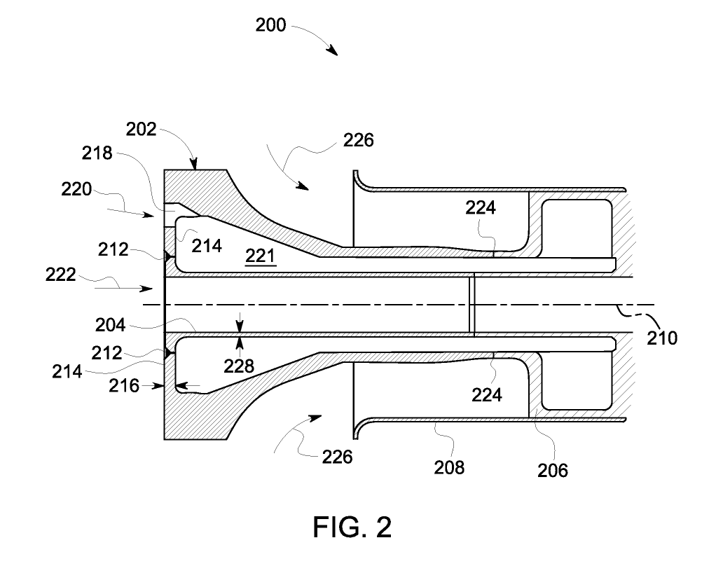

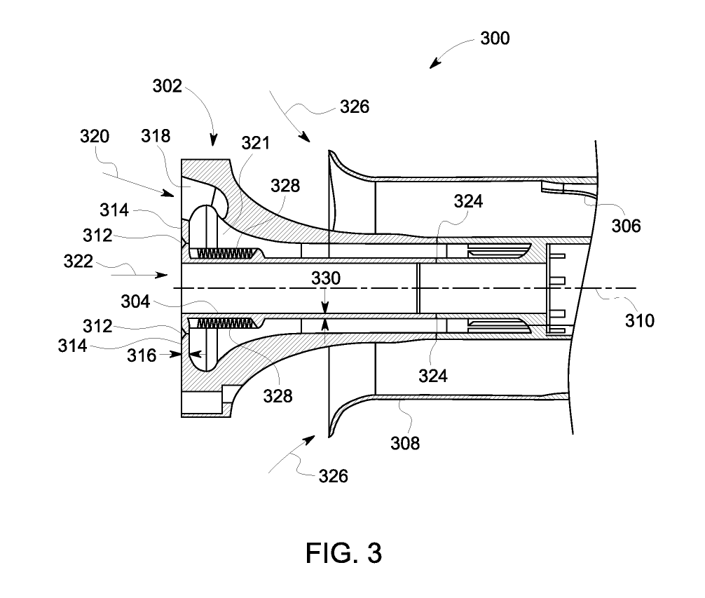

In an aspect, the combustor 104 uses liquid and/or gas fuel, such as natural gas or a hydrogen rich synthetic gas, to run the engine. For example, fuel nozzles 110 are in fluid communication with an air supply and a fuel supply 112. The fuel nozzles 110 create an air-fuel mixture, and discharge the air-fuel mixture into the combustor 104, thereby causing a combustion that creates a hot pressurized exhaust gas. The combustor 100 directs the hot pressurized exhaust gas through a transition piece into a turbine nozzle (or “stage one nozzle”), causing turbine 106 rotation. The rotation of turbine 106 causes the shaft 108 to rotate, thereby compressing the air as it flows into the compressor 102. In an embodiment, each of the fuel nozzles 110 includes a diaphragm member configured to allow relative movement of fuel nozzle 110 components. The fuel nozzle 110 components may experience relative movement due to thermal differentials and differing material expansion rates of fuel nozzle 110 components. Exemplary embodiments of the fuel nozzle 110 assemblies are discussed in detail below with reference to FIGS. 2 and 3.

FIG. 2 is a side sectional view of an embodiment of a fuel nozzle assembly 200 to be utilized in the gas turbine system 100 (FIG. 1). The fuel nozzle assembly 200 includes a flange 202, an inner conduit 204, a swozzle 206 and a shroud 208, all disposed about the nozzle axis 210. A joint 212 couples the flange 202 to the inner conduit 204 (also referred to as “inner tube”), wherein the joint 212 comprises a coupling configured to withstand high temperatures, flexing and relative movement of fuel nozzle assembly 200 components. As depicted, the flange 202 includes a diaphragm member 214 configured to flex or deform to compensate for relative movement between turbine components, such as the flange 202 and inner conduit 204. In one embodiment, the diaphragm member 214 is a radial wall in a base of the flange 202, wherein a thickness 216 of the diaphragm member 214 is configured to enable flexing of the diaphragm member 214, thus compensating for movement of the flange 202 relative to inner conduit 204. The flange 202 includes a passage 218 for a fuel flow 220 into a chamber 221. In an embodiment, the inner conduit 204 receives an air flow 222 along axis 210 within the fuel nozzle assembly 200. Air and fuel are mixed within the swozzle 206, which is coupled to the flange 202 at joint 224. The swozzle 206 receives a compressed air flow 226 from the compressor 102 (FIG. 1) to be mixed with the fuel flow 220 for combustion within combustor 104 (FIG. 1).

The diaphragm member 214 comprises a durable material configured to withstand the heat and pressure of the hot and pressurized fluid flow within fuel nozzle assembly 200. Exemplary materials may include composites and metallic or steel alloys, such as a stainless steel. Further, the diaphragm member 214 material is configured to elastically deform in response to expansion of fuel nozzle assembly 200 components, such as inner conduit 204 and flange 202. The flange comprises any suitable durable strong material, including a metallic material, a composite material or a steel alloy. In an exemplary embodiment, the flange 202 and diaphragm member 214 are formed together and comprise the same material, such as stainless steel. In other embodiments, the flange 202 and diaphragm member 214 are separate components, which may or may not be formed from the same material. In an embodiment, the fuel flow 220 is about 20 degrees Celsius as it enters the chamber 221 and the compressed air flow 226 is about 430 degrees Celsius, wherein the relatively cool fuel flow 220 causes a contraction or shrinking of the inner conduit 204 relative to the flange 202 heated by the compressed air flow 226. Thus, axial contraction, expansion and/or overall movement of the inner conduit 204 relative to flange 202 is compensated by flexing or elastic deformation of the diaphragm member 214. The elastic deformation of diaphragm member 214 is reversible. The expansion due to thermal and/or material differences between components, such as inner conduit 204 and flange 202, creates forces causing the elastic deformation of diaphragm member 214. Once the forces are no longer applied, such as when the turbine engine is cooled and not running, the diaphragm member 214 returns to its original shape.

Still referring to FIG. 2, the exemplary diaphragm member 214 comprises a stainless steel configured to withstand the flexing, pressures and temperatures within fuel nozzle assembly 200. In addition, the thickness 216 of the diaphragm member 214 ranges from about one to about five times a thickness 228 of the inner conduit 204. For example, the thickness 216 ranges from about two to about three times thickness 228. In another example, the thickness 216 is about one to about three times the thickness 228 of the inner conduit 204. The material, thickness 216, geometry and other design factors are configured to cause flexing to compensate for relative movement of turbine components, thereby reducing stress and wear on joints 212 and 224. In an embodiment, the material of the diaphragm member 214 is a stainless steel with a coefficient of thermal expansion of about 9.8×10−6 inches per inch-degree-Fahrenheit (volumetric expansion per unit temperature change). Further the stainless steel is corrosion resistant and matches the material used to form swozzle 206, thereby reducing thermal strain across the flange 202 to joint 224. In an embodiment, the joints 212 and 224 are any suitable coupling, such as welds, brazes or adhesives. As depicted, the compensation occurs without use of other mechanisms, thereby simplifying production and reducing costs while improving reliability.

FIG. 3 is a side sectional view of another embodiment of a fuel nozzle assembly 300. The fuel nozzle assembly 300 includes a flange 302, an inner conduit 304, a swozzle 306 and a shroud 308, all disposed about the nozzle axis 310. A joint 312 couples the flange 302 to the inner conduit 304, wherein the joint 312 comprises a coupling configured to withstand relative movement of fuel nozzle assembly 300 components. In addition, the flange 302 includes a diaphragm member 314 configured to flex or deform to compensate for relative movement between turbine components, such as the flange 302 and inner conduit 304. In one embodiment, the diaphragm member 314 is a radial wall in a base of the flange 302, wherein a thickness 316 of the wall is configured to enable flexing of the diaphragm member 314, thus compensating for movement of the flange 302 relative to inner conduit 304. The flange 302 includes a passage 318 for a fuel flow 320 into a chamber 321. In addition, the inner conduit 304 receives an air flow 322 along axis 310 within the fuel nozzle assembly 300. Air and fuel are mixed within the swozzle 306, which is coupled to the flange 302 at joint 324. The swozzle 306 receives compressed air flow 326 to be mixed with the fuel flow 320 for combustion within combustor 104 (FIG. 1). The fuel nozzle assembly 300 also includes bellows 328 configured to allow relative movement between inner conduit 304 and flange 302. The bellows 328 is a suitable sealing mechanism or member that allows axial and/or lateral movement of adjacent turbine components. For example, an end of bellows 328 is coupled to the flange 302 while an opposite end of the bellows 328 is coupled to inner conduit 304. In an embodiment, the bellows 328 may be described as a part of the inner conduit 304. In addition, the joints 312 and 324 are any suitable coupling, such as welds, brazes or adhesives.

The bellows 328 and diaphragm member 314 are each configured to allow expansion and movement of inner conduit 304 relative to flange 302, caused by differing material properties of the components. The material properties may include a coefficient of thermal expansion or any characteristic that affects rigidity, stiffness, shape and/or volume in response to an energy, such as temperature or pressure change. For example, the fuel flow 320 is approximately about 350 to about 450 degrees Celsius cooler than the compressed air flow 326, thereby causing the flange 302 to expand axially relative to the inner conduit 304. Accordingly, the diaphragm member 314 comprises the wall thickness 316 with a selected relationship to a thickness 330 of inner conduit 304. An embodiment of thickness 316 is about one to about five times as thick as thickness 330. Another embodiment of diaphragm member 314 has a thickness 316 about one to about three times as thick as thickness 330. Yet another embodiment of diaphragm member 314 has a thickness 316 about two to about three times as thick as thickness 330. Accordingly, the diaphragm 314 and bellows 328 are configured to elastically deform or flex to reduce wear and improve the reliability of fuel nozzle assembly 300. Accordingly, the exemplary fuel nozzle assembly 300, including diaphragm member 314 and bellows 328 are configured to compensate for movement of turbine components over time, thereby reducing stresses on the fuel nozzle assembly 300.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel nozzle assembly for a turbine, the assembly comprising:
an inner conduit; and
a flange coupled to the inner conduit thereby forming a chamber for flow of a gas fuel, wherein the flange comprises a diaphragm member coupled to the inner conduit, the diaphragm member being configured to flex in response to relative movement between the inner conduit and the flange.

2. The assembly of claim 1, wherein the diaphragm member is coupled to the inner conduit via a coupling and wherein flexing of the diaphragm member reduces stress on the coupling during axial movement of the inner conduit.

3. The assembly of claim 2, wherein the coupling comprises a weld.

4. The assembly of claim 1, wherein the diaphragm member is configured to flex to compensate for axial movement of the inner conduit due to a first property of the inner conduit relative to the flange.

5. The assembly of claim 4, wherein the first property of the inner conduit relative to the flange comprises a coefficient of thermal expansion.

6. The assembly of claim 4, wherein the axial movement is caused by a cooling of the inner conduit relative to the flange.

7. The assembly of claim 1, wherein the diaphragm member comprises a substantially radial wall with at least one passage for flow of fuel.

8. The assembly of claim 1, wherein the inner conduit provides a substantially axial flow of air and the chamber for flow of gas fuel is substantially cone-shaped and provides an axial flow of the gas fuel.

9. The assembly of claim 1, comprising a swozzle coupled to the inner conduit, wherein flexing of the diaphragm member reduces stress on couplings of the inner conduit to each of the diaphragm member and swozzle.

10. The assembly of claim 1, wherein the inner conduit comprises bellows.

11. The assembly of claim 1, wherein the diaphragm member comprises stainless steel.

12. The assembly of claim 1, wherein the diaphragm member comprises a wall and the inner conduit comprises a wall, wherein the diaphragm member wall is about one to about three times thicker than the inner conduit wall.

13. A method for flowing fuel in a turbine, the method comprising:
directing air within an inner conduit;
directing a fuel into a cavity between the inner conduit and a flange, wherein the inner conduit and flange are coupled by a coupling; and
flexing a diaphragm member in the flange to compensate for a movement of the inner conduit, wherein the flexing of the diaphragm member reduces stress on the coupling between the inner conduit and flange.

14. The method of claim 13, wherein the flexing of the diaphragm member comprises compensating for an axial movement of the inner conduit due to a cooling of the inner conduit.

15. The method of claim 13, wherein the directing the fuel comprises directing the fuel through a passage in a radial wall in a base of the flange.

16. The method of claim 13, comprising directing a compressed air outside the flange.

17. The method of claim 13, comprising mixing a compressed air with the fuel in a swozzle.

18. The method of claim 13, wherein directing the air within the inner conduit comprises directing the air through bellows.

19. The method of claim 13, wherein the coupling comprises a weld.

20. The method of claim 13, wherein flexing the diaphragm member comprises flexing a wall of the diaphragm member, wherein the diaphragm member wall is about one to about three times thicker than a wall of the inner conduit.
